(19) United States
(12) Patent Application Publication
(10) Pub. No.: US 2025/0278574 A1
(43) Pub. Date: Sep. 4, 2025

(54) SYSTEMS AND METHODS FOR PERSPECTIVE-BASED VALIDATION OF PROMPTS TO GENERATIVE ARTIFICIAL INTELLIGENCE

(71) Applicant: Wells Fargo Bank, N.A., San Francisco, CA (US)

(72) Inventors: Sadie S. Salim, Mill Valley, CA (US); Manpreet Singh, Hyderabad (IN); Michael Knorr, Fairfield, CT (US); Tyua Larsen Fraser, Livermore, CA (US)

(73) Assignee: Wells Fargo Bank, N.A., San Francisco, CA (US)

(21) Appl. No.: 18/592,464

(22) Filed: Feb. 29, 2024

(51) Int. Cl. G06F 40/40; G06F 21/60

(52) U.S. Cl. CPC G06F 40/40; G06F 21/602

(57) ABSTRACT

Aspects of this technical solution can receive, via a user interface, a first prompt for a large language model including a first query that references first data, generate one or more second prompts for the large language model based on the first prompt and the first data, each of the second prompts including one or more second data clarifying the first query, generate, by the large language model receiving one or more of the second prompts, one or more responses to the one or more second prompts, select an optimized prompt from among the one or more second prompts, according to a determination that a response to the at least one of the second prompts meets an accuracy threshold, and cause the user interface to present the optimized prompt or a response to the optimized prompt, the large language model to generate the response using the optimized prompt as input.

### TECHNICAL FIELD

The present disclosure relates to systems and methods for perspective-based validation of prompts to generative artificial intelligence. More specifically, the present disclosure relates to, but is not limited to, generating prompts that cause a generative artificial intelligence (AI) to generate accurate output, and to provide one or more suggested prompts that have been validated to provide an accurate output.

### BACKGROUND

Customers increasing demand accurate information regarding an increasingly wider range of domains. Specifically, customers increasingly access tolls that can provide detailed answers to complex inquiries. However, conventional systems cannot effectively identify inaccurate answers to customer queries at a level commensurate with the increase in complexity of queries and increase in generally available information.

### SUMMARY

At least one aspect is directed to a system. The system can include one or more processing circuits including at least one memory storing instructions therein that are executable by one or more processors. The system can receive, via a user interface, a first prompt for a large language model can include a first query that references first data. The system can generate one or more second prompts for the large language model based on the first prompt and the first data, each of the one or more second prompts including one or more second data clarifying the first query. The system can generate, by the large language model receiving one or more of the second prompts, one or more respective responses to the one or more second prompts. The system can select an optimized prompt from among the one or more second prompts, according to a determination that a response to the at least one of the second prompts meets an accuracy threshold. The system can cause the user interface to present at least one of the optimized prompt or a response to the optimized prompt, the large language model to generate the response using the optimized prompt as input.

At least one other aspect is directed to a method. The method can include receiving, via a user interface, a first prompt for a large language model that can include a first query that references first data. The method can include generating one or more second prompts for the large language model based on the first prompt and the first data, each of the one or more second prompts including one or more second data clarifying the first query. The method can include generating, by the large language model receiving one or more of the second prompts, one or more respective responses to the one or more second prompts. The method can include selecting an optimized prompt from among the one or more second prompts, according to a determination that a response to the at least one of the second prompts meets an accuracy threshold. The method can include causing the user interface to present at least one of the optimized prompt or a response to the optimized prompt, the large language model to generate the response using the optimized prompt as input.

Still one other aspect is directed to a non-transitory computer readable medium can include one or more instructions stored thereon and executable by a processor. The processor can receive, via a user interface, a first prompt for a large language model including a first query that references first data. The processor can generate one or more second prompts for the large language model based on the first prompt and the first data, each of the one or more second prompts including one or more second data clarifying the first query. The processor can generate, by the large language model receiving one or more of the second prompts, one or more respective responses to the one or more second prompts. The processor can select an optimized prompt from among the one or more second prompts, according to a determination that a response to the at least one of the second prompts meets an accuracy threshold. The processor can cause the user interface to present at least one of the optimized prompt or a response to the optimized prompt, the large language model to generate the response using the optimized prompt as input.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 depicts a computing system, according to an example embodiment.

FIG. 2 depicts a computer architecture, according to an example embodiment.

FIG. 3A depicts a first query perspective presentation graphical user interface, according to an example embodiment.

FIG. 3B depicts a second query perspective presentation graphical user interface, according to an example embodiment.

FIG. 3C depicts a third query perspective presentation graphical user interface, according to an example embodiment.

FIG. 4A depicts a first prompt perspective presentation graphical user interface, according to an example embodiment.

FIG. 4B depicts a second prompt perspective presentation graphical user interface, according to an example embodiment.

FIG. 5 depicts a flowchart of a method of perspective-based validation of prompts to generative artificial intelligence, according to an example embodiment.

FIG. 6 depicts a flowchart of a method of perspective-based validation of prompts to generative artificial intelligence, according to another example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

This technical solution relates to perspective-based validation of prompts to generative artificial intelligence (AI). User increasingly expect generative AI to provide detailed answers in an increasingly broad range of domains, including business domains that are related to sensitive or confidential data. For example, a user may provide a prompt to a generative AI to “summarize the growth of my portfolio over the last year” or “summarize the growth of portfolios of all high-net-worth individuals in my area” with respect to the user's interest area. This technical solution can identify and filter sensitive information from a user query to generate a prompt for a generative AI. As discussed herein, a query can correspond to an input entered or otherwise provided by a user, and a prompt can correspond to an input entered into a generative AI system. A query can be modified into a prompt at least as discussed herein, and a prompt can be further modified into another prompt at least as discussed herein.

The technical solution described herein can also generate a validated prompt for a given query, or class of queries, that has a lower risk of containing false information. For example, a system can validate a prompt by requesting information extrinsic to the content of a query, corresponding to “additional information” as discussed herein. For example, the generative AI can include a chatbot or other user interface to request information in addition to the content of the query from the user. For example, a system according to this disclosure can modify a prompt to a generative AI system based on context of the query provided by the user. For example, the system can modify he prompt by adding to a query with text indicative of the additional information to, in an embodiment, create a modified query that includes additional context indicative of the additional information.

As described herein, the system can modify or expand a prompt based on the query to include additional information. This “additional information” can provide an additional “perspective” on or regarding the original query, by expanding or modifying on the original query entered by the user. For example, a first perspective may correspond to a query of “tell me which companies have exceeded market expectations on revenue this quarter.” The system may modify the first or original query to include or be a first different perspective can include content to “tell me which companies have exceeded market expectations on revenue this quarter, according to their SEC filings.” The system may modify the first or original query to include or be a first different perspective can include content to “tell me which companies have exceeded market expectations on revenue this quarter, according to current reporting in news publication X.”

The system can provide one or more prompts according to an original query to one or more generative AI systems, and determine a divergence between responses. A divergence may correspond to a generative AI that returns a different list of companies from a plurality of prompts from various other perspectives. The system can determine that the diverging results are likely to be a “hallucination” of the generative AI, and can discard or downrank those results. The system can validate many prompts with respect to many queries, and can store validated prompts for later usage. The system can include an access control (e.g., smart contract) mechanism to selectively provide validated prompts based on one or more access criteria (e.g., execution of subscription agreement by smart contract). Thus, a system according to this disclosure can provide a technical improvement to increase accuracy and decrease output corresponding to “AI hallucination” in response to increasingly complex and targeted queries.

Technically and beneficially, the systems, methods, and computer-readable media described herein may transform a query into a plurality of modified queries having related context, according to a text concatenation or text replacement process based on data received to clarify one or more terms in the query. For example, the system can execute a chatbot application to solicit definitions, alternatives, or synonyms of one or more terms of a query, and can add to or replace any of those terms with the definitions, alternative or synonyms to modify a “perspective” of the query, resulting the modified queries each having a different perspective driven by its distinct content. The system can execute a large language model using each of the modified queries to generate a response for each of the queries. The system can compare each of the modified queries (e.g., compare text content, parts of speech) to identify one or more queries that include content that is substantially the same or that is substantially different, according, for example to a percentage of common characters, text, tokenized text, list elements, or any combination thereof. The system can generate a convergence metric indicative of the similarity between any of the responses, and can compare the convergence metric to a convergence threshold (e.g., the convergence threshold can be indicative of 80%, 90% or 95% same content). In some embodiments, the system can execute a plurality of differently tuned or trained large language models each to generate the responses, to provide a technical improvement to test queries for convergence or divergence across a plurality of large language models. Thus, the technical solution can provide computational efficiency in identifying responses with veracity, by imputing veracity to convergent responses that can be generated at a rate and at a level of verifiability beyond the capability of manual processes.

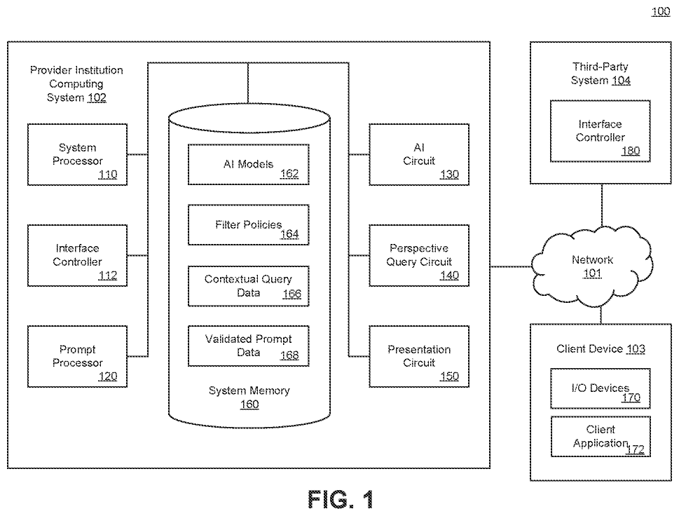

Referring now to FIG. 1, a system according is shown, according to an example embodiment. As illustrated by way of example in FIG. 1, a system 100 can include at least a network 101, a provider institution computing system 102, a client device 103, and a third-party system 104. The provider institution computing system 102 can correspond to a cloud system, a server, a distributed remote system, or any combination thereof. For example, the provider institution computing system 102 can include an operating system to execute a virtual environment. The operating system can include hardware control instructions and program execution instructions. The operating system can include a high-level operating system, a server operating system, an embedded operating system, or a boot loader.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP Internet protocol suite can include application layer, transport layer, Internet layer (including, e.g., IPv6), or the link layer. The network 101 can include a type of a broadcast network, a telecommunications network, a data communication network, or a computer network.

The provider institution computing system 102 is owned by, associated with, or otherwise operated by a provider institution (e.g., a bank or other financial institution, but is not limited thereto). The provider institution may have a system, employee (e.g., a hiring director, HR lead, recruiter, etc.), individual, or department that maintains one or more devices operable to obtain and analyze business information related to a given entity or organization unit within the entity (e.g., a team member of a wealth management department for a given customer class). For example, the team member may be the client associated with the client device 103, such as computer accessing a business organization network, a laptop accessing a user portal site, and so on. In some instances, the provider institution computing system 102, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider institution computing system 102 may be or may include various other devices communicably coupled thereto, such as, for example, desktop or laptop computers (e.g., tablet computers), smartphones, wearable devices (e.g., smartwatches), and/or other suitable devices.

The provider institution computing system 102 can include a system processor 110, an interface controller 112, a prompt processor 120, at least one AI circuit 130, at least one perspective query circuit 140, a presentation circuit 150, and a system memory 160. The system memory 160 can correspond to a non-transitory computer-readable medium. In an aspect, the non-transitory computer readable medium can include one or more instructions executable by the system processor 110. The processor can transmit, to the user interface, a third prompt for a user that can include a second query to clarify at least one of the first query and the first content. The processor can obtain, via the user interface, a response to the third prompt, the response to the third prompt can include the second data clarifying at least one of the first query and the first data.

The system processor 110 can execute one or more instructions associated with the provider institution computing system 102. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the provider institution computing system 102 generally can include one or more communication bus controllers to effect communication between the system processor 110 and the other elements of the provider institution computing system 102.

The interface controller 112 is a controller structured or configured to link the provider institution computing system 102 with one or more of the network 101, the client device 103, and the third-party system 104, by one or more communication interfaces. A communication interface can include, for example, an application programming interface (“API”) compatible with a particular component of the provider institution computing system 102, the client device 103, or the third-party system 104. The communication interface can provide a particular communication protocol compatible with a particular component of the provider institution computing system 102 and a particular component of the client device 103. The interface controller 112 can be compatible with particular content objects and can be compatible with particular content delivery systems corresponding to particular content objects, structures of data, types of data, or any combination thereof. For example, the interface controller 112 can be compatible with transmission of video content, audio content, image data, or any combination thereof. For example, the interface controller 112 can be compatible with a first artificial intelligence model and a second artificial intelligence model to receive as inputs natural text queries/requirements and to send as outputs generated text, audio, or visual postings or descriptions.

The prompt processor 120 is configured or structured to analyze, parse, inspect, or otherwise process an input/prompt/query received from the client device 103, and can generate one or more prompts from one or more perspectives as input for one or more generative AI systems. The prompt processor 120 can include an electronic processor, an integrated circuit, or the like including one or more of digital logic, analog logic, digital sensors, analog sensors, communication buses, volatile memory, nonvolatile memory, and the like. The prompt processor 120 can include, but is not limited to, at least one microcontroller unit (MCU), microprocessor unit (MPU), central processing unit (CPU), graphics processing unit (GPU), physics processing unit (PPU), embedded controller (EC), or the like. The prompt processor 120 may tokenize the query and encode the tokens for applying to one or more neural networks of the AI circuits 130. The prompt processor 120 can detect a particular structure or format of the input or the query and can generate a query having a particular structure or format, based on the input.

The at least one AI circuit 130 is configured or structured to provide one or more data transformations according to one or more perspectives as discussed herein, where the data transformations are semantically meaningful. Specifically, the AI circuits 130 may include at least one generative AI circuit (“genAI circuit”). Additionally, the AI circuits 130 may include a neural network (such as a generative pre-trained transformer neural network) trained to generate responses to queries. The neural network may be trained using data from, at least, the system memory 160. In this the regard, the neural network(s) may be trained using the standardized, labeled data ingested or otherwise received from the external source(s) and internal source(s). For example, the system memory 160 may include filters, queries, and prompts relevant to financial data for one or more individuals, companies, or markets, sectors, or any combination thereof. For example, the neural network(s) may be trained using at least the financial data discussed herein and can include publicly-available information within or external to a financial institution. The neural network(s) may be trained by tokenizing the dataset, initializing the weights and biases of the neural network(s), feeding inputs (e.g., example queries) to the neural network(s), and using a loss function to quantify discrepancies between the response to the queries generated by the neural network(s) and the answer. The neural network(s) may update the weights/biases based on the output/discrepancy until the neural network(s) satisfies various testing/training criteria. At the deployment stage, the neural network(s) may be configured to receive the encoded tokenized query as an input (e.g., to an input layer of the neural network(s)), perform forward propagation of the encoded tokens to the neural network, extract features, perform non-linear transformations, perform contextual understanding, and generate an output.

The at least one perspective query circuit 140 is configured or structured to modify one or more prompts to reduce AI hallucinations. For example, the perspective query circuits 140 can include one or more digital logic circuits or portions of a circuit to obtain information extrinsic to a query or prompt, and to modify or augment the query or prompt into prompts that include the extrinsic information. Information extrinsic to the prompt refers to information received via user input or a search engine that is not part of content of the query or prompt. For example, a query can include the text “tell me the best place to invest in rental properties” that does not include the location of the user submitting the query. Here, the perspective query circuit 140 can cause the client device 103 to provide a geolocation for the user, or the perspective query circuit 140 can cause the client device 103 to present a chatbot request for additional information regarding a preferred geographic area for the investment activity. For example, the perspective query circuits 140 can provide one or more of the prompts augmented with specific examples (“San Francisco, Chicago, Dallas, New York City, and Los Angeles”) of broad categories (“major metropolitan areas”) or can add additional information to an existing prompt. In response to receiving the additional information “Dallas” from the user via the client device 103 (e.g., via a user input in response to a chatbot request), the perspective query circuit 140 can modify the query into a prompt having content of “tell me the best place to invest in rental properties in Dallas.” The perspective query circuits 140 can provide the augmented prompts to one or more generative AI systems that can be included in the perspective query circuits 140 or coupled therewith.

The perspective query circuit 140 is configured or structured to identify differences between the responses to each of the augmented prompt and the original prompt, for example, and can discard or downrank results from a prompt that do not appear in the others. For example, the perspective query circuit 140 is configured to detect a difference between characters, tokens, lists element or words of text content as discussed herein, and to determine whether the difference satisfies an accuracy threshold. For example, the accuracy threshold can be indicative of an agreement of a minimum percentage of matches between characters, tokens, list element or words of text content as discussed herein, but is not limited thereto. Thus, the perspective query circuits 140 can provide a technical improvement to identify “AI hallucination” without a reliance on ground-truth data, to increase accuracy of responses of generative Ai systems at a level beyond the capability of manual processes to achieve.

The presentation circuit 150 is configured or structured to generate and provide one or more outputs at least partially corresponding to a response by the output from the AI circuits 130 or the perspective query circuit 140. For example, the presentation circuit 150 can generate or transform a structure of data corresponding to a response to correspond to a particular user interface or a particular characteristic. For example, the presentation circuit 150 can select a user interface corresponding to a structure of data corresponding the user interface and can transmit the response having the particular data structure to one or more user interfaces configured to present the response according to the structure. For example, the presentation circuit 150 can be configured to provide responses in various formats, including for example text outputs, table outputs, visual or graphical outputs, and so forth, or to instruct or cause a user interface to provide responses in various formats. The presentation circuit 150 may be configured to generate the responses at the client device 103.

The system memory 160 can store data associated with the provider institution computing system 102. For example, the data associated with the provider institution computing system 102 can include, but is not limited to, customer identification (e.g., full name, address, demographic information), customer account information, customer financial product preferences, customer marketing preferences, customer financial profile information, customer peer group information, client industry, active or inactive accounts (e.g., mortgages, loans, liabilities), account usage history, sector or market identifiers, or any combination thereof. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include AI models 162, filter policies 164, a contextual query data 166, and a validated prompt data 168.

The AI models 162 can include one or more data sets corresponding to trained generative AI models or metrics for training generative AI models. For example, the AI models 162 can include one or more generative AI models trained with respect to one or more given datasets relevant to the financial institution. In one example and because the provider institution is shown as a financial institution herein, the AI models 162 can receive as input one or more objects corresponding to financial data associated with the provider institution computing system 102. The filter policies 164 can include one or more data sets corresponding to criteria for restricting or removing confidential or sensitive information from a query or prompt. For example, the filter policies 164 can identify one or more predefined values, data types, or customer properties (e.g., identifying information) to be removed from the query before transmission to a generative AI system. For example, a predefined value to be removed from the query is a Social Security Number, or a number having a format matching a format of a Social Security Number (e.g., ###-##-####). For example, a data type to be removed from the query is an account value data field of a customer account record. For example, a customer property to be removed from the query is a full name or a home address.

The contextual query data 166 can include one or more data sets corresponding to different perspectives of various queries, or metrics for generating different perspectives of queries. For example, the contextual query data 166 can include a data structure including a decision tree graph for coaching a chatbot to identify different perspectives in conversation with a querying user. For example, the contextual query data 166 can store fragments of queries corresponding to various queries or prompts that can be retrieved by the perspective query circuits 140 to increase the number of available perspectives for a given prompt. The validated prompt data 168 can include one or more data sets corresponding to prompts that have been validated as having a low risk of AI hallucination. For example, the validated prompt data 168 can include one or more validated prompts each associated with one or more queries, types of queries, prompts, types of prompts, customers, types of customers, products, types of products, or any combination thereof. For example, the validated prompt data 168 can correspond to one or more secure data tokens (e.g., non-fungible tokens (“NFTs”) that can be accessed via smart contracts to provide various ones of the validated prompts to one or more users (e.g., according to a subscription by the user's entity to the prompts.

In an embodiment, the client device 103 is owned, operated, controlled, managed, and/or otherwise associated with a team member of the provider institution. In another embodiment, the client device is owned, operated, controlled, managed, and/or otherwise associated with a client of the provider institution. In another embodiment, the client device is owned, operated, controlled, managed, and/or otherwise associated with a third-party associated with the provider institution (e.g., data vendor, search engine provider). In some embodiments, the client device 103 may be or may comprise, for example, a desktop or laptop computer (e.g., a tablet computer), a smartphone, a wearable device (e.g., a smartwatch), a personal digital assistant, and/or any other suitable computing device. In the example shown, the client device 103 is structured as a mobile computing device, namely a smartphone. The client device 103 can communicate with the provider institution computing system 102 by the network 101 via one or more communication protocols therebetween. The client device 103 can include a display device. The display device can display at least one or more user interfaces and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. As a specific example, the client device 103 can be or include a chatbot application configured to receive a prompt relevant to data of the provider institution, and request one or more data inputs corresponding to “additional information” as discussed herein. While only one client device 103 is depicted, it is to be appreciated that a plurality of computing devices accessible by one or more separate individuals, entities, or the like may be included with the provider institution computing system 102.

Additionally, the client device 103 includes one or more I/O devices 170, a network interface circuit, and one or more client applications. While the term “I/O” is used, it should be understood that the I/O devices may be input-only devices, output-only devices, and/or a combination of input and output devices. In some instances, the I/O devices include various devices that provide perceptible outputs (such as display devices with display screens and/or light sources for visually perceptible elements, an audio speaker for audible elements, and haptics or vibration devices for perceptible signaling via touch, etc.), that capture ambient sights and sounds (such as digital cameras, microphones, etc.), and/or that allow the recruiter or manager to provide inputs (such as a touchscreen display, stylus, keyboard, force sensor for sensing pressure on a display screen,

The I/O devices 170 can include a display configured to present a user interface or graphical user interface. The I/O devices 170 can include a user interface presentable on a display device operatively coupled with or integrated with the client device 103. The I/O devices 170 can output at least one or more user interface presentations and control affordances. The I/O devices 170 can generate any physical phenomena detectable by human senses, including, but not limited to, one or more visual outputs, audio outputs, haptic outputs, or any combination thereof. In the example shown, the client device 103 includes a provider institution client application 172. The provider institution client application 172 may be provided by and at least partly supported by the provider institution computing system 102. In this regard, the client application 172 coupled to the provider institution computing system 102 may enable a user to conduct one or more financial transactions or banking activities with the provider institution computing system 102 or a financial institution associated with the provider institution computing system 102. In this regard, the client application 172 coupled to the provider institution computing system 102 may also enable a user to filter a prompt to remove confidential or sensitive information that may otherwise be provided to a large language model, and can enable the user to identify one or more validated prompts through an interact chatbot interface to identify content or “additional information” relevant to a query to a large language model. In the example shown, the provider institution client application 172 may be a query input, refinement, selection, and execution interface that enables various large language models to identify and execute input prompts that have been validated for use with the large language model by the provider institution computing system 102. In some instances, the client application 172 provided by the provider institution computing system 102 may additionally be coupled to the network 101 (e.g., via one or more application programming interfaces (APIs), webhooks, and/or software development kits (SDKs)) to integrate one or more features or services provided by the third-party system 104. In some instances, the client application 172 may be provided as a web-based feature or application.

The third-party system 104 can include a computing system associated with a third-party from the user and the provider, and distinct from the provider institution computing system and the client device 103. For example, the third-party system 104 can correspond to a cloud system, a server, a distributed remote system, or any combination thereof. For example, the third-party system 104 can include an operating system to execute a virtual environment. The operating system can include hardware control instructions and program execution instructions. The operating system can include a high-level operating system, a server operating system, an embedded operating system, or a boot loader. The third-party system 104 can include an interface controller 180. The interface controller 180 can correspond at least partially to one or more of structure and operation to the interface controller 112. For example, the third-party system 104 is a server operated by a search engine provider, that includes or is coupled with a search engine circuit to provide results of a search query via the interface controller 180. One or more components of the provider institution computing system 102 can communicate bidirectionally with the third-party system 104 via the interface controller 112 to transmit requests and receive responses (e.g., search results) from the third-party system 104.

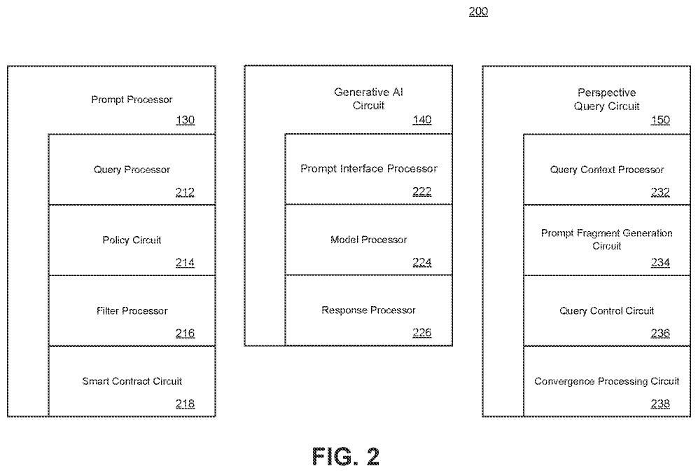

Referring now to FIG. 2, a computer architecture for the AI circuits 130 of the provider institution computing system 102 is shown, according to an example embodiment. As illustrated by way of example in FIG. 2, a computer architecture 200 can include at least the prompt processor 130, the perspective query circuit 140, and the perspective query circuit 230. The computer architecture 200 may include one or more AI circuits or models which receive input via the user interface, generate or modify prompts according to one or more perspectives, and validate one or more prompts based on convergence or divergence between responses generated by each of the prompts from various perspectives. The prompt processor 130 can include a query processor 212, a policy circuit 214, a filter processor 216, and a smart contract circuit 218.

The query processor 212 is configured or structured to receive an input. The input may be a text input, a voice input, an image input, a video input, or any combination thereof. The input (e.g., query) may be received from the client device 103. For example, the query may include a phrase, question, or directive structured in a natural language (e.g., English) to request a response from a generative AI system. The query processor 212 may be configured to tokenize the text input into tokens (e.g., phrases, passages, individual words, sub-words, punctuation, etc.). The prompt processor 120 query processor 212 may be configured to transform, convert, or otherwise encode each token generated for the text input into an encoded token. The encoded token may be encoded into a format (such as vector format, word embeddings, etc.) that is compatible with the presentation circuit 150 or one or more user interfaces corresponding to the presentation circuit 150, as described herein.

The policy circuit 214 is configured or structured to obtain one or more filter policies 164 from the system memory 160. The policy circuit 214 can identify one or more confidential or sensitive aspects of a query and can identify one or more filters among the filter policies 164. The policy circuit 214 can provide one or more filters to the filter processor 216 to apply to one or more queries or prompts. For example, the policy circuit can filter a query or a prompt by a name recognition operation. For example, the policy circuit 214 can receive a query for “identify my top financial products including synthetic assets for Client A” from a user via the client device 103. Based on that query, the policy circuit 214 can identify one or more references in the content of the query to personally identifiable information (e.g., the name of Client A). The policy circuit can then obtain a name recognition filter linked with or corresponding to client names and can provide that filter to a reference to that filter to the filter processor 216. The policy circuit is not limited to a name recognition filter as discussed herein, and perform operations using one or more of a location recognition filter, a product recognition filter, a demographic recognition filter, or any combination thereof.

The filter processor 216 is configured or structured to apply one or more filters to one or more portions of a query or a prompt to restrict transmission of confidential information or sensitive information to a generative AI system. The filter processor 216 can receive a filter received from the policy circuit 214 as applicable to the fragment of the query and can apply that filter to the fragment of the query or any text associated with or surrounding the fragment. For example, the filter processor 216 can replace “Client A” with a more general term “Fortune 100 company” to prevent the name of the client from being transmitted to the generative AI system. Thus, the filter processor 216 can achieve a technical solution to automatically parse queries and prompts according to data restriction criteria associated with a given organization (e.g., financial institution), to achieve at least a technical improvement to apply custom redactions to input data beyond the capability of manual processes to achieve. In an aspect, the filter processor 216 can filter the first data from the first prompt according to a determination that the large language model is located at a first computing device distinct from a second computing device storing the first data, where the first data is restricted from transmission according to a security policy that prevents transmission of the first data from the first computing device.

The smart contract circuit 218 is configured or structured to link one or more prompts with one or more smart contracts or tokens associated with smart contacts, and can determine whether to provide a prompt to the generative AI circuit or the presentation circuit 150 according to one or more criteria of a smart contract. For example, the smart contract circuit 218 can generate or modify one or more smart contracts to restrict access to a prompt to one or more entities holding a token to unlock the smart contract. For example, a token can correspond to an NFT that provides an access key to a given prompt. For example, a company can purchase a subscription to a prompt library relevant to one or more of the company's businesses, and the company can receive access to the prompts according to one or more smart contracts linked with prompts relevant to the company.

In an aspect, the smart contract circuit 218 can generate a non-fungible token (NFT) based on the optimized prompt. The smart contract circuit 218 can cause a blockchain provider system to register the NFT for the optimized prompt to a blockchain for one or more optimized prompts. For example, a company can operate one of the client devices, or a server coupled to one or more of the provider institution computing system 102 and the client device 103 via the network 101. The smart contract circuit 218 can provide one or more circuits to execute one or more smarts contracts configured according to one or more aspects of a generative AI system. For example, the smart contract circuit 218 can execute smart contracts that are configured to be unlocked only in response to detecting a communication interface with a generative AI system, and to provide a prompt only directly to that generative AI system via the detected communication interface. For example, the communication interface with the generative AI system can correspond to an internal communication interface of the provider institution computing system 102, or an external communication interface to a third-party generative AI system via the interface controller 112. In an aspect, the smart contract circuit 218 can generate a non-fungible token (NFT) based on the optimized prompt. The smart contract circuit 218 can cause a blockchain provider system to register the NFT for the optimized prompt to a blockchain for one or more optimized prompts.

In an embodiment, the perspective query circuit 140 is a processor or processing circuit configured or structured to communicate and receive inputs, structured data, and/or other values from the prompt processor 130 to create narrative text in response to a prompt received by the prompt processor 130. For example, the perspective query circuit 140 may include a large language model that is structured to provide a grammatically correct and descriptive natural text/semantic description that includes features such as customer information, financial performance historically, predicted financial performance, comparative analyses, or any combination thereof. 140Altternatilvey or additionally, the perspective query circuit 140 can be linked with a large language model external to the provider institution computing system 102 (e.g., a large language model platform provided by the third-party system 104). The perspective query circuit 140 can include a prompt interface processor 222, a model processor 246, and a response processor 226.

The prompt interface processor 222 is configured or structured to receive and parse data received from the prompt processor 130 (e.g., in the form of a prompt). The prompt interface processor 222 can receive and modify one or more queries based on one or more criteria. For example, the prompt interface processor 222 can modify a structure of data corresponding to a query to correspond to a model according to the model processor 224. For example, the prompt interface processor 222 can receive a text input and modify a natural language portion of the text input to correspond to a generative artificial intelligence model. In some respects, the prompt interface processor 222 can receive inputs such as characteristics of a business entity, historical properties of the entity (e.g., historical stock performance), or market sector/industry cohort information relative to the entity (e.g., key competitors, peers, etc.). In further examples, the prompt interface processor 222 can receive an image input (e.g., a stock chart, image data depicting P&L data, etc.) and modify a prompt to include information from the image input to correspond to a generative artificial intelligence model.

The model processor 224 is a processor or processing circuit configured or structured to serve as a core of the perspective query circuit 140. Specifically, the model processor 224 may receive the relevant data, metrics, and/or information processed from the prompt interface processor 222. For example, the model processor 224 is a generative AI system or is linked with an external generative AI system. For example, the model processor 224 can include one or more instances of a generative AI system or can execute, either sequentially or in parallel, a plurality of generative AI systems. For example, the model processor 224 can identify a plurality of generative AI models from the AI models 162, where each of the identified AI models is relevant to a prompt, a fragment of a prompt, a filter, or any combination thereof, for a given query. The model processor 224 can, for example, execute one or more AI models to identify convergence or divergence between responses to one or more prompts from one or more perspectives as discussed herein. For example, the model processor 224 can include, or be communicatively coupled with a machine learning circuit including a large language model (LLM) processor. In an aspect, the model processor 224 can generate, by the large language model receiving the first prompt, a third prompt for a user can include a second query to clarify at least one of the first query and the first content.

The response processor 226 is a processor or processing circuit configured or structured to refine and apply additional formatting or metadata to a response generated by the model processor 224. For example, the response processor 226 can embed metadata into the response indicative of filters applied, or indicative of which portions of the prompt corresponding to an original query and which portions of the prompt correspond to fragments added according to a perspective query. The response processor 226 may apply post-generation tasks like grammar checking, formatting. Additionally, the response processor 226 may generate notations and commentary regarding the generative AI system or model used to generate the particular response, as part of an audit trace of the prompt.

The perspective query circuit 230 can include a query context processor 232, a prompt fragment generation circuit 234, a query control circuit 236, and a convergence processing circuit 238. The query context processor 232 is configured or structured to identify one or more aspects of a query or prompt and can generate one or more requests based on those aspects. For example, an aspect of a query can be a name, location, identifier, age, preference, or demographic, but is not limited thereto. The query context processor 232 can determine as aspect of a query based on metadata from a user account or a property of the client device 103. For example, a user using the client application 172 may login. In response to the login by the user, the client device 103 can transmit device information (e.g., location, MAC address) and application info (e.g., user identifier) to the provider institution computing system 102. The provider institution computing system 102 can correlate one or more of the received device information and the application information to the account of the user.

Then, we may know the GPS/location of the device based on the login indication being transmitted. For example, the query context processor 232 can include a natural language processor, be linked with a natural language processor as discussed herein to identify one or more of the aspects. For example, a natural language processor can be configured to identify nouns, proper nouns, according to a part-of-speech recognition circuit. For example, a natural language processor can be configured to identify one or more customers, entities, sectors, financial products, financial documents, or any combination thereof relevant to a customer or financial institution, according to a part-of-speech recognition circuit that is configured according to one or more of the filter policies 164, the contextual query data 166, the validated prompt data 168, or any combination thereof. The query context processor 232 can include or be linked with a conversation interface (e.g., chatbot application) to generate one or more user requests corresponding to the prompt. For example, the query context processor 232 can identify a location “southern California” in a user prompt for “Show me net value of accounts for aerospace companies in southern California” and can generate a user request including text of “Why are you interested in southern California?” For example, the query context processor 232 can identify entities “aerospace companies” in the user prompt and can generate a user request including text of “Are you interested in any specific aerospace markets or platforms?” Thus, the query context processor 232 can elicit additional information extrinsic to a query that is relevant to a query (e.g., “context” of the query).

The prompt fragment generation circuit 234 is configured or structured to generate one or more data objects based on additional information identified or obtained by the query context processor 232. For example, the prompt fragment generation circuit 234 can include or link with a natural language processor as discussed herein, to generate one or more natural language phrases to augment or modify a given prompt or query. For example, the prompt fragment generation circuit 234 can generate a fragment including text of “in Orange County, CA” or “the California Space Coast” in response to identifying the location “southern California” in a query. The prompt fragment generation circuit 234 can modify a query to replace content of a query with additional content. For example, the prompt fragment generation circuit 234 can modify a query to “Show me net value of accounts for aerospace companies in Orange County, CA” or “Show me net value of accounts for aerospace companies on the California Space Coast” based on the received example query noted above. The prompt fragment generation circuit 234 can augment a query to replace content of a query with additional content. For example, the prompt fragment generation circuit 234 can modify a query to “Show me net value of accounts for aerospace companies in southern California, including Orange County, CA” or “Show me net value of accounts for aerospace companies in southern California, including on the California Space Coast” based on the received example query noted above. Each of these examples of modified or augmented queries can correspond to queries having different perspectives with respect to location. However, the prompt fragment generation circuit 234 is not limited to making a single augmentation or single modification based on a single element corresponding to a location.

In this way, the modified or augmented prompt can correspond to a second prompt as discussed herein. In an aspect, the prompt fragment generation circuit 234 can generate each of the one or more second prompts having a different one of the one or more second data. In an aspect, the prompt fragment generation circuit 234 can present, via the user interface, one or more of the second prompts. The prompt fragment generation circuit 234 can obtain, via the user interface, a selection of one or more of the second prompts. The provider institution computing system 102 can select the optimized prompt from among a subset of the second prompts selected via the user interface.

The query control circuit 236 is configured or structured to instruct the prompt processor 130 or the query processor 212 to execute a generative AI system with input including one or more of the modified prompts or the augmented prompts. For example, the query control circuit 236 can provide a plurality of prompts corresponding to an input prompt, where each augmented or modified prompt is a permutation including zero or more fragments of additional information identified or generated by the prompt fragment generation circuit 234. For example, the query control circuit 236 can parallelize execution of a plurality of prompts from various perspectives, to provide a technical improvement to rapidly generate related generative AI results beyond the capability of manual processes to achieve.

The convergence processing circuit 238 is configured or structured to compare a plurality of responses to prompts to identify a “hallucination” corresponding to false information is present in output of one or more of the responses. For example, the convergence processing circuit 238 can compare one or more entities of text (e.g., nouns, descriptions, lists, names, dates, or any combination thereof) to determine whether any of the entities have values that differ between responses or are absent from one or more instances of responses to various modified or augmented prompts. For example, the convergence processing circuit 238 can determine that a response of a plurality of responses (e.g., 5% of hundreds of modified or augmented responses) based on a prompt, contains a list of places with entries that do not match entries in a plurality of other responses (e.g., 75% of the hundreds of modified or augmented responses) based on the prompt. The convergence processing circuit 238 can identify corresponding elements between prompts by a natural language processor as discussed herein, but is not limited thereto. For example, the convergence processing circuit 238 can identify corresponding elements between prompts by identifying clusters of characters, words or phrases. Thus, the convergence processing circuit 238 can provide a technical improvement to approximate the veracity of responses by a generative AI system, by identifying differences between responses (e.g., divergence) or commonalities between responses (e.g., convergence).

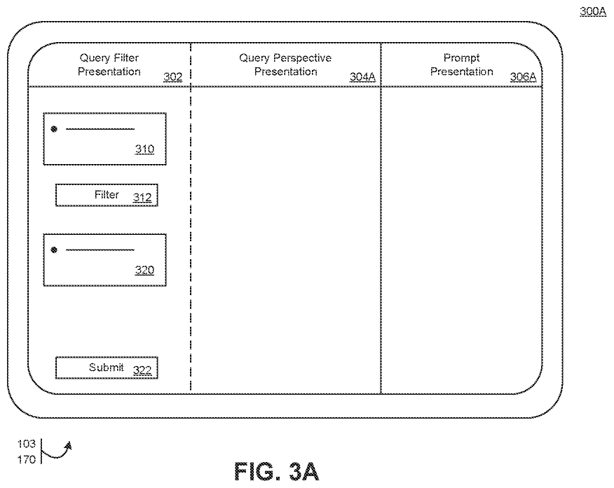

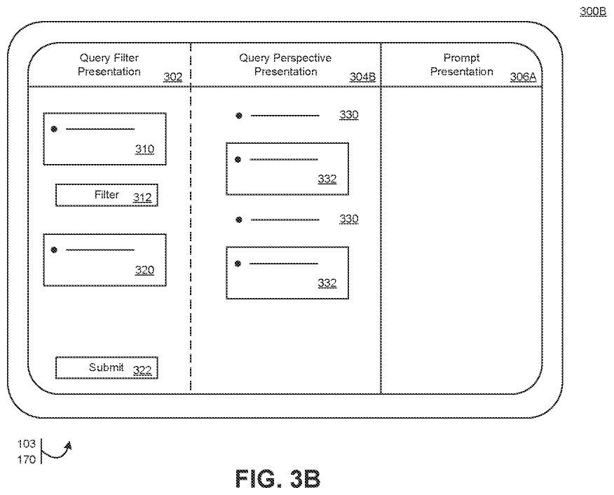

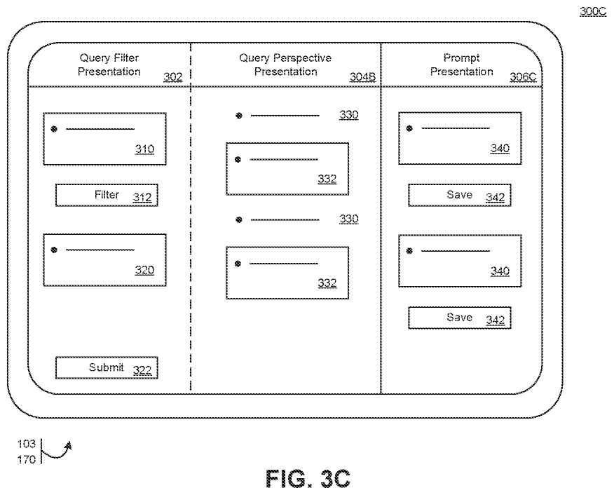

Referring now to FIG. 3A, a first query perspective presentation is shown according to an example embodiment. As illustrated by way of example in FIG. 3A, a first query perspective presentation 300A can include at least a query filter presentation 302, a query perspective presentation 304A, and a prompt presentation 306A. For example, the I/O devices 170 of the client device 103 corresponding to a display device can generate output corresponding to the presentation 300A. The query filter presentation 302 can correspond to a portion of a user interface presented at the display device of the I/O devices, to present one or more graphical user interface elements to capture and remove confidential or sensitive information associated with one or more queries. The query filter presentation 302 can include a query input field 310, a query filter button 312, a filtered query field 320, and a query submit button 322.

The query input field 310 can include a graphical user interface for a text box, and can receive one or more queries or input text corresponding to a query. For example, each query can be preceded by a bullet or graphical element indicating the start of the query. For example, a user can enter text into the query input field 310 including a query having confidential or sensitive information. The query filter button 312 can include a graphical user interface for a button to cause the client device 103 to transmit a query to the provider institution computing system 102 and receive a filtered query from the provider institution computing system 102. For example, the query filter button 312 can cause the filter processor 216 to generate output and transmit that output to the client device 103. The filtered query field 320 can include a graphical user interface for a text box and can present an output received from the filter processor 216 corresponding to a query having some or all identified confidential or sensitive content therein removed. The query submit button 322 can include a graphical user interface for a button to cause the client device 103 to transmit a filtered query to the prompt interface processor 222. For example, the query submit button 322 can cause the filter processor 216 or the client device 103 to transmit the filtered query to the prompt interface processor 222.

The query perspective presentation 304A can correspond to a portion of a user interface presented at the display device of the I/O devices, to present one or more graphical user interface elements to obtain additional information associated with one or more queries. As discussed herein, additional information can correspond to context that identify one or more perspectives associated with the query as discussed herein. The query perspective presentation 304A can correspond to a state of a portion of the user interface of the client device 103 before activation (e.g., clicking or tapping) of the query submit button 322. Thus, the query perspective presentation 304A can correspond to an inactive or unpopulated portion of the graphical user interface of the first query perspective presentation 300A. The prompt presentation 306A can correspond to a portion of a user interface presented at the display device of the I/O devices, to present one or more graphical user interface elements to present and save one or more validated prompts associated with one or more queries. The prompt presentation 306A can correspond to a state of a portion of the user interface of the client device 103 before activation (e.g., clicking or tapping) of the query submit button 322. Thus, the prompt presentation 306A can correspond to an inactive or unpopulated portion of the graphical user interface of the first query perspective presentation 300A.

Referring now to FIG. 3B, a second query perspective presentation is shown, according to an example embodiment. As illustrated by way of example in FIG. 3B, a second query perspective presentation 300B can include at least a query perspective presentation 304B. For example, the I/O devices 170 of the client device 103 corresponding to a display device can generate output corresponding to the second query perspective presentation 300B. The query perspective presentation 304B can correspond to a portion of a user interface presented at the display device of the I/O devices, to present one or more graphical user interface elements to obtain additional information associated with one or more queries. The query perspective presentation 304B can correspond to a state of a portion of the user interface of the client device 103 after activation (e.g., clicking or tapping) of the query submit button 322. Thus, the query perspective presentation 304B can correspond to an active or populated portion of the graphical user interface of the second query perspective presentation 300B. The query perspective presentation 304B can include context responses 330, and context input fields 332.

The context responses 330 can include a graphical user interface for a text object, to present one or more outputs of the query context processor 232. For example, the context responses 330 can include a sequence of questions generated by a chatbot associated with or integrated with the query context processor 232. The context input fields 332 can include a graphical user interface for a text box and can receive one or more responses of input text indicative of additional information with respect to the filtered query submitted to the query perspective presentation 304B. For example, each response can be preceded by a bullet or graphical element indicating the start of the query. For example, a user can enter text into each of the context input fields 332. The context responses 330 and the context input fields 332 can be populated in pairs, to provide a chatbot interface. The query perspective presentation 304B can present pairs of the context responses 330 and the context input fields 332 until a number of responses have been received, or the query context processor 232 has provided all requests. In response, the convergence processing circuit 238 can cause the user interface to proceed to present a user interface according to FIG. 3C. For example, each of the context responses 330 can correspond to a respective third prompt as discussed herein. For example, text entered by a user into each of the context input fields 332 can correspond to a respective second data clarifying the first query or the first data. In an aspect, one or more of the I/O devices 170 can transmit, to the user interface, the third prompt. The one or more of the I/O devices 170 can obtain, via the user interface, a response to the third prompt, the response to the third prompt can include the second data clarifying at least one of the first query and the first data. In an aspect, the interface controller 112 can transmit, to a search engine, one or more of the second prompts. The interface controller 112 can obtain, from the search engine, one or more responses to the second prompts. The one or more of the I/O devices 170 can determine, based on one or more responses to the second prompts, that the response to the at least one of the second prompts meets the accuracy threshold. For example, the query context processor 232 can interface with a search engine via the interface controller to obtain one or more of the context responses 330.

Referring now to FIG. 3C, a third query perspective presentation is shown, according to an example embodiment. As illustrated by way of example in FIG. 3C, a third query perspective presentation 300C can include at least a prompt presentation 306C. For example, the I/O devices 170 of the client device 103 corresponding to a display device can generate output corresponding to the third query perspective presentation 300C. The prompt presentation 306C can correspond to a portion of a user interface presented at the display device of the I/O devices, to present one or more graphical user interface elements to present and save one or more validated prompts associated with one or more queries. The prompt presentation 306A can correspond to a state of a portion of the user interface of the client device 103 after activation (e.g., clicking or tapping) by the convergence processing circuit 238. Thus, the prompt presentation 306C can correspond to an active or populated portion of the graphical user interface of the third query perspective presentation 300C. The prompt presentation 306C can include optimized prompt presentation fields 340, and prompt save buttons 342.

The optimized prompt presentation fields 340 can include a graphical user interface for a text box and can present one or more validated prompts corresponding to a query. For example, each query can be presented in response to a determination that the validated prompt has a divergence that is below an accuracy threshold (e.g., all data is present in 7% of responses to prompts with permutations of perspectives) that indicates convergence, and thus implies veracity. The prompt save buttons 342 can include a graphical user interface for a button to cause the provider institution computing system 102 to store a validated prompt to the validated prompt data 168 portion of the system memory 160. For example, the prompt save buttons 342 can each cause the smart contract circuit 218 to save corresponding validated prompts and to generate or modify smart contracts linked with one or more of the validated prompts. In an aspect, the convergence processing circuit 238 can determine that the response meets the accuracy threshold based on a difference between presence of one or more words in the response and one or more words in each of the responses, where the accuracy threshold is a maximum difference between words among the responses.

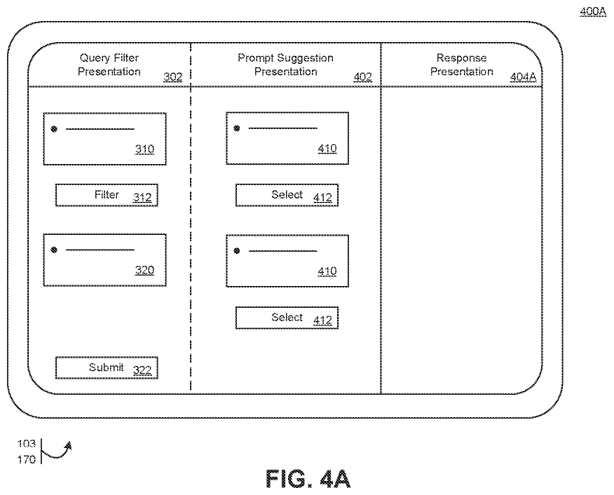

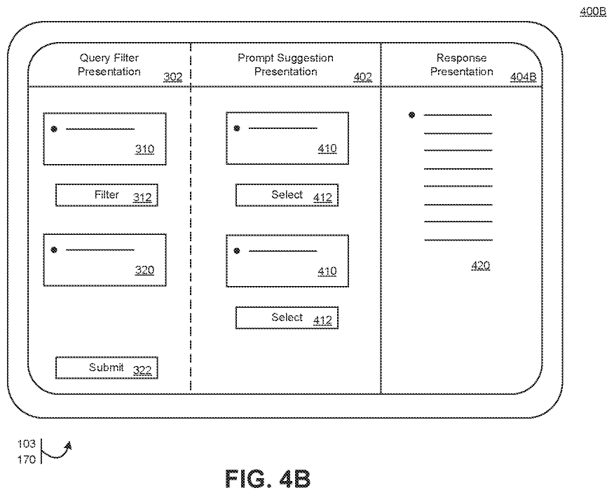

Referring now to FIG. 4A, a first prompt perspective presentation is shown, according to an example embodiment. As illustrated by way of example in FIG. 4A, a first prompt perspective presentation 400A can include at least a prompt suggestion presentation 402, and a response presentation 404A. For example, the I/O devices 170 of the client device 103 corresponding to a display device can generate output corresponding to the presentation 400A. The prompt suggestion presentation 402 can correspond to a portion of a user interface presented at the display device of the I/O devices, to present one or more graphical user interface elements to present one or more prompts stored as the validated prompt data 168. The prompt suggestion presentation 402 can correspond to a state of a portion of the user interface of the client device 103 after activation (e.g., clicking or tapping) of the query submit button 322. The prompt interface processor 222 can obtain one or more validated prompts stored as the validated prompt data 168, according to a determination by the prompt interface processor 222 that the filtered query is linked with a validated prompt or a smart contract that restricts transmission of the validated prompt. For example, the prompt interface processor 222 can present the retrieved prompts in response to a detection by the client device 103 of user input to activate the query submit button 322. Thus, the prompt suggestion presentation 402 can correspond to an active or populated portion of the graphical user interface of the first prompt perspective presentation 400A. The prompt suggestion presentation 402 can include an optimized prompt presentation fields 410, and a prompt select button 412.

The optimized prompt presentation fields 410 can include a graphical user interface for a text box and can present one or more validated prompts linked with a filtered query. For example, each validate prompt can be presented in response to a determination that the validated prompt has been generated in response to a previously-generated query that shares one or more natural language properties with the filtered query, according to convergence criteria discussed herein. The prompt select button 412 can include a graphical user interface for a button to cause the perspective query circuit 140 to transmit a response to the validated prompt selected at the prompt suggestion presentation 402. For example, the prompt select button 412 can cause the model processor 224 and the response processor 226 to generate and transmit the response to the validated prompt to the filtered query to the client device 103 (e.g., the client application 172). The response presentation 404A can correspond to a portion of a user interface presented at the display device of the I/O devices, to present one or more graphical user interface elements to present one or more responses to one or more validated prompts. The response presentation 404A can correspond to a state of a portion of the user interface of the client device 103 before activation (e.g., clicking or tapping) of the prompt select button 412. Thus, the response presentation 404A can correspond to an inactive or unpopulated portion of the graphical user interface of the first prompt perspective presentation 400A.

Referring now to FIG. 4B, a second prompt perspective presentation is shown, according to an example embodiment. As illustrated by way of example in FIG. 4B, a first prompt perspective presentation 400B can include at least a generative response presentation 404B. For example, the I/O devices 170 of the client device 103 corresponding to a display device can generate output corresponding to the presentation 400B. The response presentation 404B can correspond to a portion of a user interface presented at the display device of the I/O devices, to present one or more graphical user interface elements to present one or more responses to one or more validated prompts. The response presentation 404B can correspond to a state of a portion of the user interface of the client device 103 after activation (e.g., clicking or tapping) of the prompt select button 412. Thus, the response presentation 404B can correspond to an active or populated portion of the graphical user interface of the second prompt perspective presentation 400B. The response presentation 404B can include a generative response content 420.

The generative response content 420 can include a graphical user interface for a text object, to present one or more outputs of the perspective query circuit 140. For example, the generative response content 420 can include a text object listing by revenue of the top 10 aerospace companies in southern California that are clients, and can indicate an estimated aggregate amount of revenue to a company or a financial institution, based on the returned companies. For example, the perspective query circuit 140 can present the response as discussed herein, in response to a prompt based on the query “Show me net value of accounts for aerospace companies in southern California, including on the California Space Coast” as discussed herein.

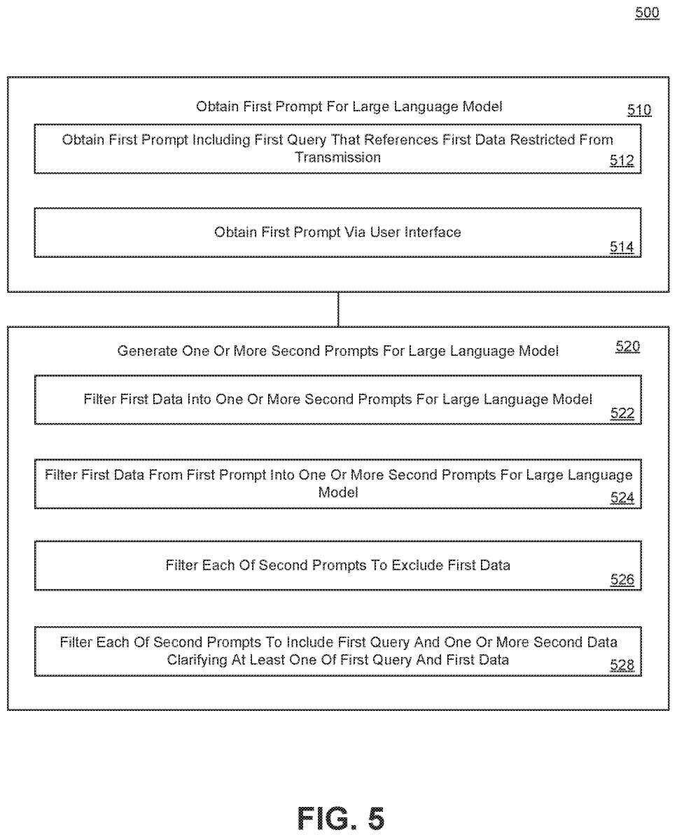

Referring now to FIG. 5, a method of perspective-based validation of prompts to generative artificial intelligence is shown, according to an example embodiment. At least the system 100, the computer architecture 200, or any component thereof as discussed herein, can perform method 500. At 510, a first prompt for a large language model is obtained. For example, the prompt processor 120 obtains the first prompt for a large language model. At 512, the first prompt is obtained including a first query that references first data restricted from transmission. At 514, the first prompt is obtained via a user interface. For example, a user interface presented by the I/O devices 170 of the client device can obtain the first prompt.

At 520, one or more second prompts are generated for the large language model. For example, a first prompt is a query submitted by a user. For example, the filter processor 216 can generate the one or more second prompts according to one or more of the filter policies 164. At 522, the first data is filtered into one or more second prompts for the large language model. In an aspect, the method can include filtering the first data from the first prompt according to a determination that the large language model is located at a first computing device distinct from a second computing device storing the first data, where the first data is restricted from transmission according to a security policy that prevents transmission of the first data from the first computing device. At 524, the first data is filtered from the first prompt into one or more second prompts for the large language model. In an aspect, the method can include transmitting, to a search engine, one or more of the second prompts. The method can include obtaining, from the search engine, one or more responses to the second prompts. The method can include determining, based on one or more responses to the second prompts, that the response to the at least one of the second prompts meets the accuracy threshold. At 526, each of the second prompts is filtered to exclude the first data. At 528, each of the second prompts is filtered to include the first query and one or more second data clarifying at least one of the first query and the first data. In an aspect, the method can include generating each of the one or more second prompts having a different one of the one or more second data.

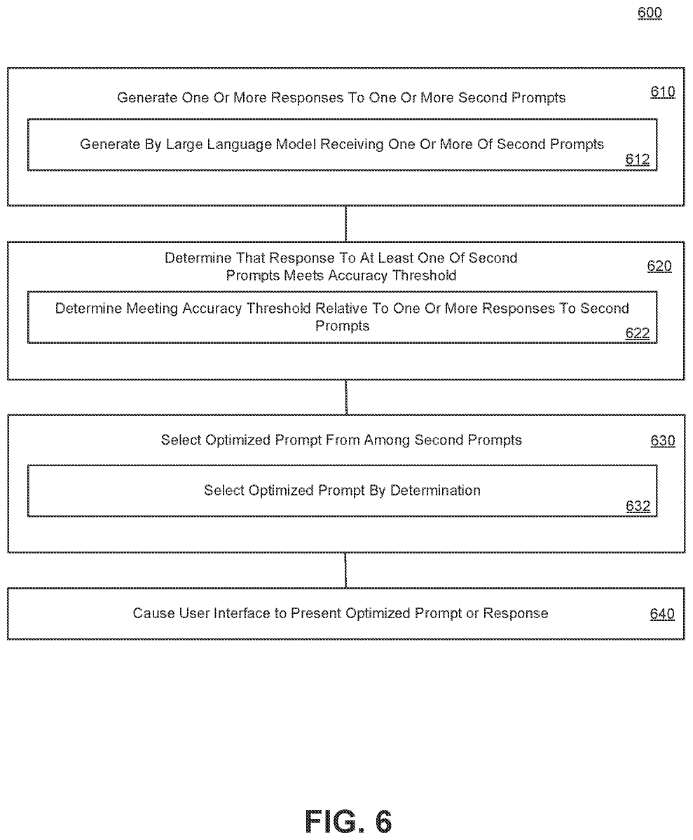

Referring now to FIG. 6, a method of perspective-based validation of prompts to generative artificial intelligence is shown, according to another example embodiment. At least the system 100, the computer architecture 200, or any component thereof as discussed herein, can perform method 600. At 610, one or more responses to the one or more second prompts are generated. For example, the machine learning circuit 130 can generate the one or more responses to the one or more second prompts. At 612, one or more responses to the one or more second prompts are generated by the large language model receiving one or more of the second prompts. For example, the machine learning circuit 130 can receive one or more of the second prompts to generate the one or more responses. In an aspect, the method can include generating, by the large language model receiving the first prompt, a third prompt for a user can include a second query to clarify at least one of the first query and the first content.

At 620, it is determined that a response to the at least one of the second prompts meets an accuracy threshold. For example, the convergence processing circuit can determine that the response to the at least one of the second prompts meets the accuracy threshold. At 622, meeting the accuracy threshold can be determined relative to one or more responses to the second prompts. In an aspect, the method can include determining that the response meets the accuracy threshold based on a difference between presence of one or more words in the response and one or more words in each of the responses, where the accuracy threshold is a maximum difference between words among the responses.

At 630, an optimized prompt is selected from among the second prompts. For example, the perspective query circuit 230 can select an optimized prompt from among the second prompts. At 632, the optimized prompt is selected according to the determination. For example, the determination is the determination that a response to the at least one of the second prompts meets an accuracy threshold, as discussed herein. In an aspect, the method can include presenting, via the user interface, one or more of the second prompts. The method can include obtaining, via the user interface, a selection of one or more of the second prompts. The method can include selecting the optimized prompt from among a subset of the second prompts selected via the user interface. At 640, the optimized prompt or a response to the optimized prompt is presented. For example, the presentation circuit 150 causes one or more of the I/O devices 170 to generate a graphical user interface to present at least one of the optimized prompt or a response to the optimized prompt. For example, the perspective query circuit 140 causes the large language model to generate the response using the optimized prompt as input.

In an aspect, the method can include transmitting, to the user interface, the third prompt. The method can include obtaining, via the user interface, a response to the third prompt, the response to the third prompt can include the second data clarifying at least one of the first query and the first data. In an aspect, the method can include generating a non-fungible token (NFT) based on the optimized prompt. The method can include causing a blockchain provider system to register the NFT for the optimized prompt to a blockchain for one or more optimized prompts.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein and are not limited to the directional indicators depicted herein. Any directional indicator depicted herein can be modified to the reverse direction or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

Example computing systems and devices may include one or more processing units each with one or more processors, one or more memory units each with one or more memory devices, and one or more system buses that couple various components including memory units to processing units. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated modules, units, and/or engines, including processor instructions and related data (e.g., database components, object code components, script components, etc.), in accordance with the example embodiments described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system, comprising:
one or more processing circuits comprising memory storing instructions therein that is executable by one or more processors to cause the one or more processors to:
receive, via a user interface, a first prompt for a large language model including a first query that references first data;
generate one or more second prompts for the large language model based on the first prompt and the first data, each of the one or more second prompts including one or more second data clarifying the first query;
generate, by the large language model receiving one or more of the second prompts, one or more respective responses to the one or more second prompts;
select an optimized prompt from among the one or more second prompts, according to a determination that a response to the at least one of the second prompt meets an accuracy threshold; and
cause the user interface to present at least one of the optimized prompt or a response to the optimized prompt, the large language model to generate the response using the optimized prompt as input.

2. The system of claim 1, the processors configured to:
filter the first data from the first prompt into the one or more second prompts, each of the one or more second prompts excluding the first data and including one or more second data clarifying the first query, wherein the restricted data is restricted from transmission.

3. The system of claim 1, the processors configured to:
generate, by the large language model receiving the first prompt, a third prompt for a user including a second query to clarify at least one of the first query and the first content. transmit, to the user interface, the third prompt; and
obtain, via the user interface, a response to the third prompt, the response to the third prompt including the second data clarifying at least one of the first query and the first data.

4. The system of claim 1, the processors configured to:
generate each of the one or more second prompts having a different one of the one or more second data.

5. The system of claim 1, the processors configured to:
present, via the user interface, one or more of the second prompts;
obtain, via the user interface, a selection of one or more of the second prompts; and
select the optimized prompt from among a subset of the second prompts selected via the user interface.

6. The system of claim 1, the processors configured to:
determine that the response meets the accuracy threshold based on a difference between presence of one or more words in the response and one or more words in each of the responses, wherein the accuracy threshold is a maximum difference between words among the responses.

7. The system of claim 1, the processors configured to:
filter the first data from the first prompt according to a determination that the large language model is located at a first computing device distinct from a second computing device storing the first data,
wherein the first data is restricted from transmission according to a security policy that prevents transmission of the first data from the first computing device.

8. The system of claim 1, the processors configured to:
transmit, to a search engine, one or more of the second prompts;
obtain, from the search engine, one or more responses to the second prompts; and
determine, based on one or more responses to the second prompts, that the response to the at least one of the second prompts meets the accuracy threshold.

9. The system of claim 1, the processors configured to:
generate a non-fungible token (NFT) based on the optimized prompt; and
cause a blockchain provider system to register the NFT for the optimized prompt to a blockchain for one or more optimized prompts.

10. A method, comprising:
receiving, via a user interface, a first prompt for a large language model including a first query that references first data;
generating one or more second prompts for the large language model based on the first prompt and the first data, each of the one or more second prompts including one or more second data clarifying the first query;
generating, by the large language model receiving one or more of the second prompts, one or more respective responses to the one or more second prompts;
selecting an optimized prompt from among the one or more second prompts, according to a determination that a response to the at least one of the second prompts meets an accuracy threshold; and
causing the user interface to present at least one of the optimized prompt or a response to the optimized prompt, the large language model to generate the response using the optimized prompt as input.

11. The method of claim 10, further comprising:
filtering the first data from the first prompt into the one or more second prompts, each of the one or more second prompts excluding the first data and including one or more second data clarifying the first query, wherein the restricted data is restricted from transmission.

12. The method of claim 10, further comprising:
generating, by the large language model receiving the first prompt, a third prompt for a user including a second query to clarify at least one of the first query and the first content;
transmitting, to the user interface, the third prompt; and
obtaining, via the user interface, a response to the third prompt, the response to the third prompt including the second data clarifying at least one of the first query and the first data.

13. The method of claim 10, further comprising:
generating each of the one or more second prompts having a different one of the one or more second data.

14. The method of claim 10, further comprising:
presenting, via the user interface, one or more of the second prompts;
obtaining, via the user interface, a selection of one or more of the second prompts; and
selecting the optimized prompt from among a subset of the second prompts selected via the user interface.

15. The method of claim 10, further comprising:
determining that the response meets the accuracy threshold based on a difference between presence of one or more words in the response and one or more words in each of the responses, wherein the accuracy threshold is a maximum difference between words among the responses.

16. The method of claim 10, further comprising:
filtering the first data from the first prompt according to a determination that the large language model is located at a first computing device distinct from a second computing device storing the first data,
wherein the first data is restricted from transmission according to a security policy that prevents transmission of the first data from the first computing device.

17. The method of claim 10, further comprising:
transmitting, to a search engine, one or more of the second prompts;
obtaining, from the search engine, one or more responses to the second prompts; and
determining, based on one or more responses to the second prompts, that the response to the at least one of the second prompts meets the accuracy threshold.

18. The method of claim 10, further comprising:
generating a non-fungible token (NFT) based on the optimized prompt; and
causing a blockchain provider system to register the NFT for the optimized prompt to a blockchain for one or more optimized prompts.

19. A non-transitory computer readable medium including one or more instructions stored thereon and executable by a processor to:
receive, via a user interface, a first prompt for a large language model including a first query that references first data;
generate one or more second prompts for the large language model based on the first prompt and the first data, each of the one or more second prompts including one or more second data clarifying the first query;
generate, by the large language model receiving one or more of the second prompts, one or more respective responses to the one or more second prompts;
select an optimized prompt from among the second prompts, according to a determination that a response to the at least one of the second prompts meets an accuracy threshold; and
cause the user interface to present at least one of the optimized prompt or a response to the optimized prompt, the large language model to generate the response using the optimized prompt as input.

20. The non-transitory computer readable medium of claim 19, the non-transitory computer readable medium further including one or more instructions executable by the processor to:
generate, by the large language model receiving the first prompt, a third prompt for a user including a second query to clarify at least one of the first query and the first content;
transmit, to the user interface, a third prompt for a user including a second query to clarify at least one of the first query and the first content; and
obtain, via the user interface, a response to the third prompt, the response to the third prompt including the second data clarifying at least one of the first query and the first data.
